(19) United States
(12) Patent Application Publication
(10) Pub. No.: US 2002/0144235 A1
(43) Pub. Date: Oct. 3, 2002

(54) Debugging embedded systems

(76) Inventors: Charles Simmers, Phoenix, AZ (US); Joseph W. Triece, Phoenix, AZ (US)

Correspondence Address: RONALD L. CHICHESTER, BAKER BOTTS L.L.P., ONE SHELL PLAZA, 901 LOUISIANA STREET, HOUSTON, TX, 77002-4995, US

(21) Appl. No.: 09/822,739

(22) Filed: Mar. 30, 2001

(51) Int. Cl. G06F 9/44

(52) U.S. Cl. 717/124

(57) ABSTRACT

An embedded system is provided with the capability to be debugged. The embedded system includes a central processing unit (CPU) that is coupled to a bus having certain contents. A register, also with contents, is available for loading by the CPU. Finally, a debug logic circuit is also included. The debug logic circuit is coupled to both the bus and the CPU. The debug circuit itself is composed of a breakpoint detect circuit that is coupled to the bus and to the register. This circuitry enables a breakpoint signal that is produced by the breakpoint detect circuit when the contents of the register equal the contents of the bus. A method is also provided for debugging an embedded system having a microcontroller with a CPU. First, a debug logic circuit that resides on the same chip as the microcontroller is programmed to detect a predetermined condition in the microcontroller. Next, application software is run on the microcontroller. When a predetermined condition is detected, the CPU is interrupted which provides the ability to view the condition of the microcontroller. Programming the debug logic circuit can include the storing of a breakpoint address in a breakpoint address register. Afterward, a program memory address bus is selected for comparison to the contents of the breakpoint address register, upon which time a breakpoint counter is set to zero. The steps of interrupting and detecting are accomplished by comparing the contents of the program memory address bus to the contents of the breakpoint register and, if they are equal, then the CPU is interrupted.

### FIELD OF THE INVENTION

The present invention relates generally to background debuggers, and more particularly to on-chip debuggers, and even more particularly to on-chip debuggers for microcontrollers.

### BACKGROUND OF THE INVENTION TECHNOLOGY

In recent years, microprocessors have become almost commonplace in electronic devices. Indeed, even household appliances, such as washing machines, refrigerators and water heaters, may include microprocessors to control some aspect of their operation. A microprocessor used in such an application is frequently referred to as a “microcontroller.” An application that incorporates a microprocessor is sometimes called an “embedded system,” because the control for the system is embedded in the system rather than being external to the system.

One of the challenges of testing embedded systems is that the microcontroller and the system it is controlling are frequently so intertwined as to make testing the microcontroller apart from the system, or vice versa, very difficult. In the past, engineers have addressed this problem by using “in-circuit emulators,” or ICEs, which are sophisticated systems that emulate the operation of the microprocessor through a cable and connector that connect in the place usually occupied by the microprocessor.

ICE systems typically allow a user to set “breakpoints” in the microprocessor code. Generally, the breakpoints are associated with a condition of the microprocessor, such as a program address being accessed, a data address being accessed or some other event. The ICE executes software that emulates execution of the microprocessor code and monitors the condition of the emulated microprocessor to detect breakpoints. When a breakpoint is reached, the ICE stops emulating the microprocessor operation and allows the condition of the emulated microprocessor to be examined. Assuming that the emulator software is operating correctly and that it correctly emulates the microprocessor operation, an ICE system can be used to debug the hardware and software of embedded microprocessor systems.

What is needed is a debugger that will work without removing the embedded microprocessor and thus will not rely on the accuracy of an emulation.

### SUMMARY OF THE INVENTION

The invention overcomes the above-identified problems as well as other shortcomings and deficiencies of existing technologies by providing a debugging system that works without removing the embedded microprocessor. Registers provided with the system store breakpoint conditions. Logic coupled to the registers and the system busses determines when the monitored conditions occur and interrupts the system. The registers and logic are implemented in hardware which allows an embedded system to be debugged with the microprocessor or microcontroller installed in the system and running its own software or firmware. In one embodiment, the debug logic is implemented on the same chip as the microcontroller or microprocessor. In another embodiment, the debug logic is incorporated in a separate module that can be coupled to the microprocessor or microcontroller for debugging purposes.

In accordance with an exemplary embodiment of the present invention, an embedded system is provided with the capability to be debugged. The embedded system includes a central processing unit (CPU) that is coupled to a bus having certain contents. A register, also with contents, is available for loading by the CPU. Finally, a debug logic circuit is also included. The debug logic circuit is coupled to both the bus and the CPU. The debug circuit itself is composed of a breakpoint detect circuit that is coupled to the bus and to the register. This circuitry enables a breakpoint signal that is produced by the breakpoint detect circuit when the contents of the register equal the contents of the bus.

In another embodiment of the present invention, a method is disclosed for debugging an embedded system having a microcontroller with a CPU. First, a debug logic circuit that resides on the same chip as the microcontroller is programmed to detect a predetermined condition in the microcontroller. Next, application software is run on the microcontroller. When a predetermined condition is detected, the CPU is interrupted which provides the ability to view the condition of the microcontroller. Programming the debug logic circuit can include the storing of a breakpoint address in a breakpoint address register. Afterward, a program memory address bus is selected for comparison to the contents of the breakpoint address register, upon which time a breakpoint counter is set to zero. The steps of interrupting and detecting are accomplished by comparing the contents of the program memory address bus to the contents of the breakpoint register and, if they are equal, then the CPU is interrupted.

Yet another embodiment of the present invention is composed of a bus interface for interfacing to a microcontroller bus. In addition, a communications interface is included for receiving debug instructions. A register is also provided which holds the contents that can be loaded through the communications interface. A breakpoint detect circuit is coupled to the bus interface and the register. In operation, a breakpoint signal is produced by the breakpoint detect circuit when the contents of the register equal the contents of the bus.

A technical advantage of the present invention is that the debugger can be executed with the microcontroller in place in the target system and executing target system code. This eliminates reliance on ICE interpreting target system code.

Features and advantages of the invention will be apparent from the following description of the embodiments, given for the purpose of disclosure and taken in conjunction with the accompanying drawings.

### BRIEF DESCRIPTION OF THE DRAWINGS

A more complete understanding of the present disclosure and advantages thereof may be acquired by referring to the following description taken in conjunction with the accompanying drawings, wherein:

FIG. 1 is a block diagram of a target system in a debug configuration.

FIG. 2 is a block diagram of a target system.

FIG. 3 is a block diagram of a prior art microcontroller.

FIG. 4 is a block diagram of a microcontroller including on-chip debug logic.

FIG. 5 is a block diagram of a microcontroller and a separate debug module in a debug configuration.

FIG. 6 is a map of the debug registers.

FIG. 7 is a block diagram of the debug logic.

FIG. 8 is a flow chart for setting up a break on program memory address match.

FIG. 9 is a flow chart for monitoring for a program memory address match breakpoint.

FIG. 10 is a flow chart for setting up a break on number of program memory address matches.

FIG. 11 is a flow chart for monitoring for a number of program memory address matches breakpoint.

FIG. 12 is a flow chart for setting up a break on SFR address match.

FIG. 13 is a flow chart for monitoring for a SFR address match breakpoint.

FIG. 14 is a flow chart for setting up a break on SFR address and data match.

FIG. 15 is a flow chart for monitoring for a SFR address and data match breakpoint.

FIG. 16 is a flow chart for setting up a break on number of SFR address and data matches.

FIG. 17 is a flow chart for monitoring for a number of SFR address and data matches breakpoint.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

The present invention is directed to debugging embedded systems.

Referring now to the drawings, the details of an exemplary embodiment of the present invention is schematically illustrated. Like elements in the drawings will be represented by like numbers, and similar elements will be represented by like numbers with a different lower case letter suffix.

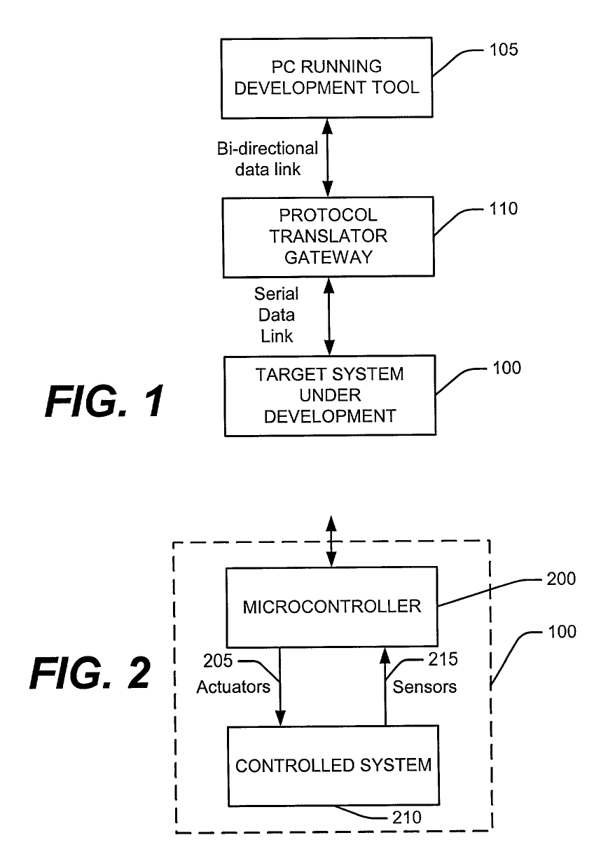

In an exemplary embodiment, illustrated in FIG. 1, a target system under development 100 is configured to be debugged under the control of a personal computer (“PC”) 105 running a development tool. An example of such a development tool is the MPLAB system, available commercially from Microchip Technology Incorporated.

A protocol translator gateway 110 contains a microcontroller which translates the commands from the PC 105 into a format acceptable to the microcontroller. In the case of microcontrollers manufactured by Microchip Technology Incorporated, the interface is a serial interface. The serial interface allows software running on the PC 105 to control the debugging of the target system 100.

In one exemplary embodiment, the target system under development, shown in more detail in FIG. 2, includes a microcontroller 200 with a serial interface to the protocol translator gateway 110. The microcontroller 200 also includes outputs 205 for controlling actuators in a controlled system 210 and inputs 215 for monitoring sensors installed in the controlled system 210. The controlled system 210 can be any kind of system susceptible to control in this manner. For example, the controlled system 210 can be a household appliance, such as a refrigerator or a water heater.

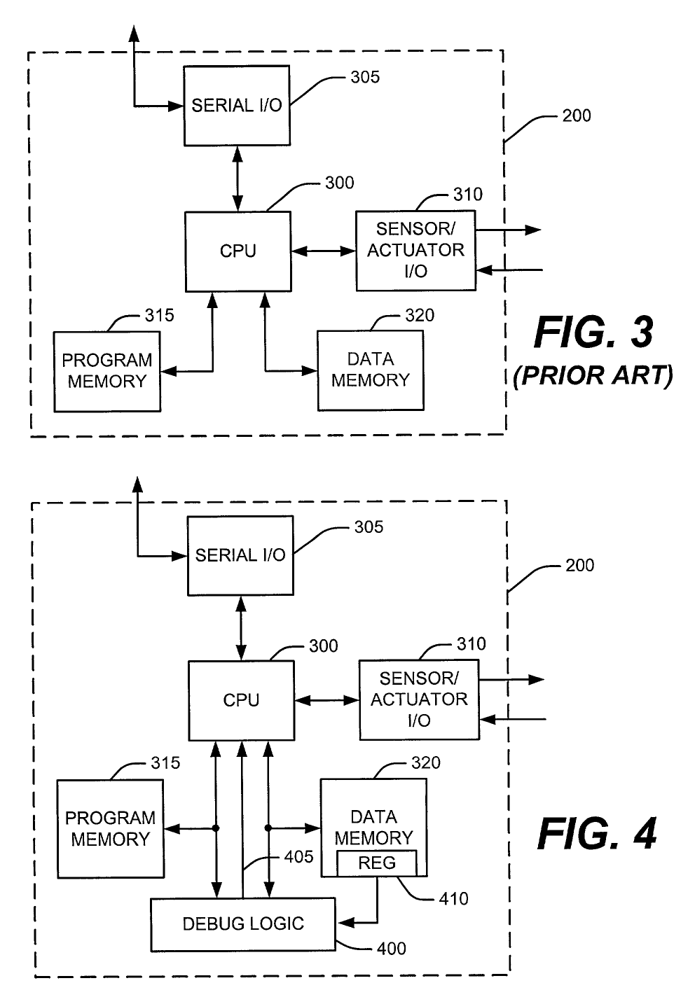

An existing microcontroller 200, illustrated in FIG. 3, includes a CPU 300, which communicates with the protocol translator gateway 110 through a serial I/O interface 305. The CPU controls actuators and reads sensors on the controlled system 210 through a sensor/actuator I/O 310. The microcontroller 200 includes a program memory 315 and a data memory 320, connected by separate busses to the CPU 300.

In one exemplary embodiment, shown in FIG. 4, the microcontroller 200 is modified to include a debug logic circuit 400. The debug logic circuit 400 interfaces with the program memory busses and the data memory busses and produces a break signal 405. The break signal 405 is coupled to a CPU input so that when the break signal 405 is activated, the CPU will be interrupted and vectored in a conventional manner to an debug interrupt vector where code is stored for executing appropriate interrupt software or firmware. In one exemplary embodiment, the data memory 320 includes a set of debug registers 410 which facilitate debugging, as described below.

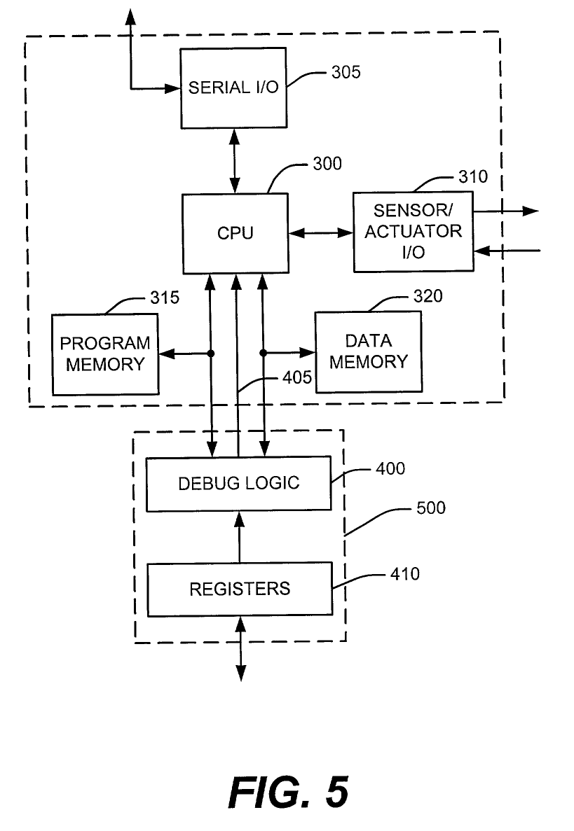

In an alternative embodiment, illustrated in FIG. 5, the debug logic circuit 400 and registers 410 are located in a module 500 separate from the microcontroller. The module 500 has a serial interface which allows it to be controlled by the PC 105 through the protocol translator gateway 110. The module 500 also has an interface that allows it to connect to the microcontroller's program memory busses and data memory busses and to provide the break signal 405, as described above.

The embodiment illustrated in FIG. 4 has the advantage that it is always available to be debugged. The disadvantage is that some space on the microcontroller chip must be devoted to the debug logic circuit. This disadvantage is mediated by the simplicity of the debug logic circuit, as shown below.

The advantage of the embodiment illustrated in FIG. 5 is that it can be applied to any microprocessor or microcontroller system in which the busses are available as shown in FIG. 5 and in which the CPU 300 has an interrupt input that can be used for debug purposes. The disadvantage of this embodiment is that a separate debug module is necessary.

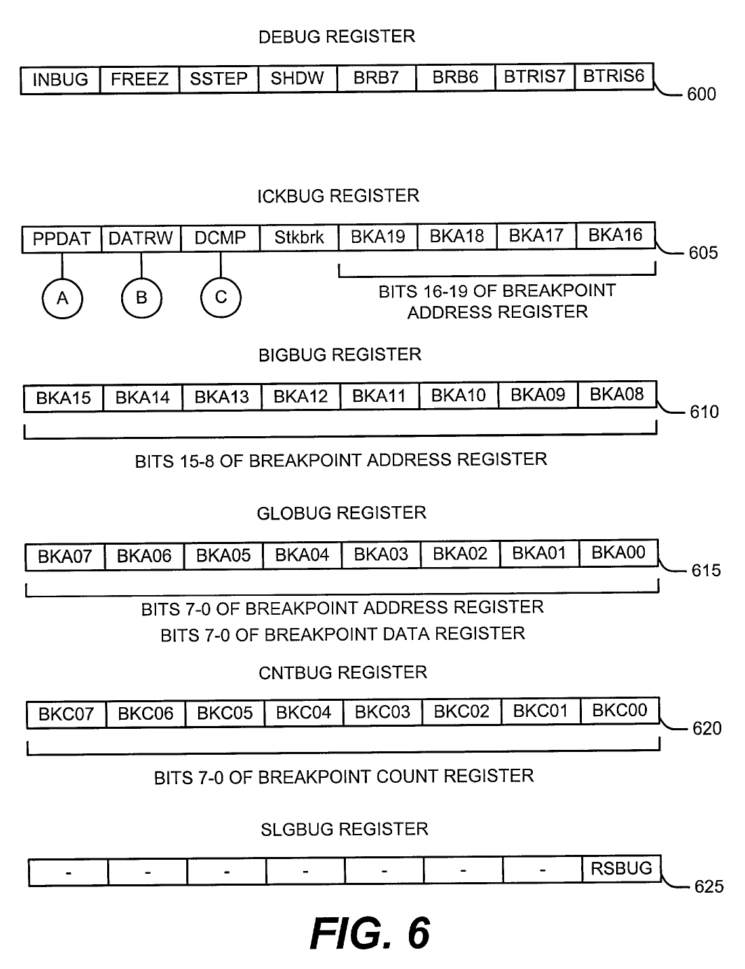

The debug registers used in one exemplary embodiment, illustrated in FIG. 6, include a DEBUG register 600, an ICKBUG register 605, a BIGBUG register 610, a GLOBUG register 615, a CNTBUG register 620 and a SLGBUG register 625. A configuration register (not shown) includes a BKBUG bit which, if set to zero, enables the background debugger hardware.

The DEBUG register includes a read-only INBUG bit which is set to “1” when the device is executing background debugger code. A FREEZ bit, when set to “1,” will cause peripherals to freeze when INBUG is set to “1.” When a SSTEP bit is set to “1,” the debug program will execute one instruction word of user code upon return from the debug code. If a SHDW bit is set to “1,” a read from breakpoint register location will yield the contents of the breakpoint registers. If the SHDW bit is set to “0,” a read from breakpoint register locations will yield the contents of device peripheral registers mapped at these locations.

The ICKBUG register includes a PPDAT bit, which is the Program Space or Data Space Compare Select Bit. When the PPDAT bit is set to “0,” the debug circuitry is in the “program break” mode, in which the value in the CNTBUG register is decremented every time the contents of the program memory address bus equals the contents of the breakpoint address register (discussed later) on instruction fetch or a fetch of a first word of a two word instruction. A breakpoint will occur when CNTBUG underflows below “0.” When the PPDAT bit is “1,” the debug circuitry is in “data break” mode, which means that the DATRW bit, see next paragraph, is enabled.

The DATRW bit is the Data Read/Write Access Select bit. If the PPDAT bit is one, the DATRW bit is set to “0,” and the File Register Address (discussed below) equals the breakpoint address on a read cycle, a break will result. If PPDAT is set to “1,” DATRW is set to “1,” and the File Register Address equals the breakpoint address on a write cycle, a break occurs. In either case, the SFR value read or written is copied into the GLOBUG register (discussed below). If the PPDAT bit equals “0,” the DATRW bit is a don't care bit.

The DCMP bit is a data compare bit. If the PPDAT bit is set to “1,” and the DCMP bit is set to “1,” the contents of the data memory data bus are compared to the contents of the GLOBUG register. If the File Register Address equals the breakpoint address and the GLOBUG register equals the data being read or written, a breakpoint occurs. If PPDAT is set to “1” and DCMP is set to “0,” no data comparison is done. If PPDAT is set to “0,” DCMP is a don't care bit.

The STKBRK bit is a Stack Overflow/Underflow Break bit. If the STKBRK bit is set to “1,” a break occurs when the stack overflows or underflows, as represented by STKOVF or STKUNF bits, respectively. If the SJKBRK bit is set to “0,” no action occurs on those conditions.

BKA19-BKA16 are Breakpoint Address bits. They are bits 19-16, respectively, of the breakpoint address register and bits 3-0 of the File Register.

The BIGBUG register includes BKA15-BKA8, which are bits 15-8, respectively, of the breakpoint address register and bits 7-0 of the File Register.

The GLOBUG register includes BKA07-BKAOO which are bits 7-0, respectively, of the breakpoint address register, or, if the PPDAT bit is set to “1,” bits 7-0 of the breakpoint data register.

The CNTBUG register includes bits BKC07-BKC00, which are breakpoint counter bits. This register holds a counter value for the number of passes to allow before break is issued, as discussed below.

The SLGBUG register includes an RSBUG bit, which is the debugger reset vector selection. If the RSBUG bit equals one, all resets will vector to address 200028H. If RSBUG equals zero, all resets will vector to 000000H.

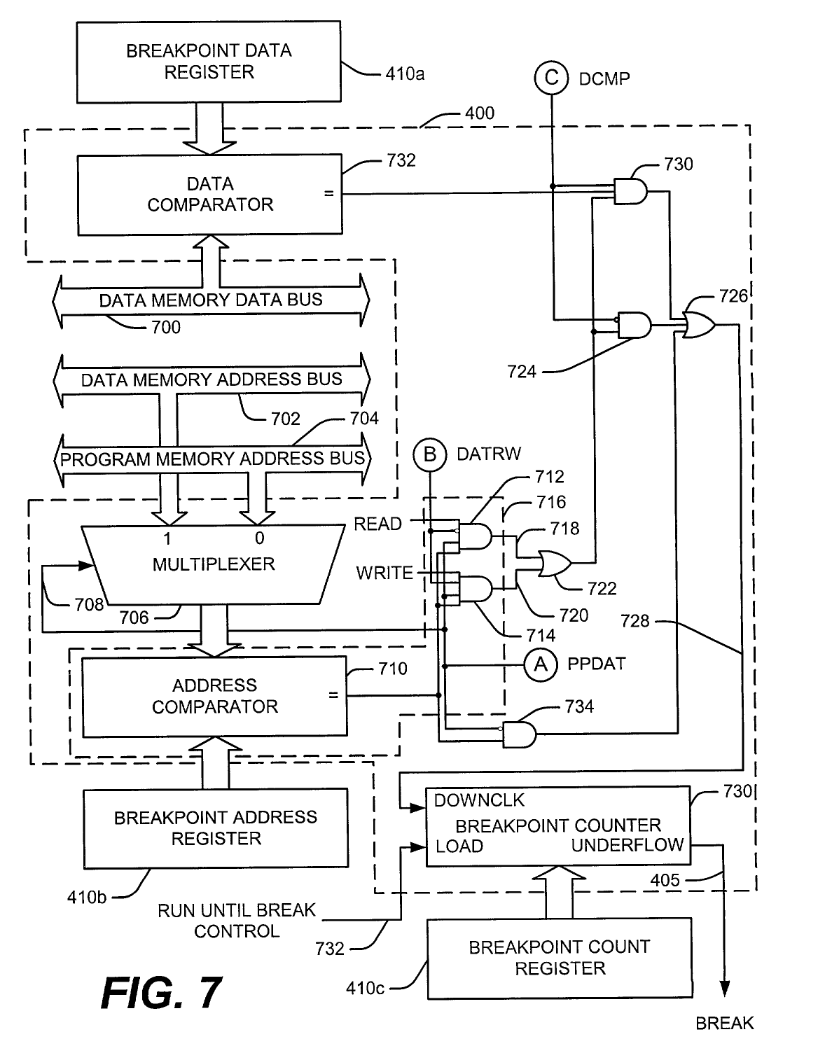

The debug logic circuit 400 and the registers 410, illustrated in more detail in FIG. 7, interface with the data memory data bus 700, the data memory address bus 702, and the program memory address bus 704, and produce the break signal 405, which is used to interrupt the CPU. The registers 410 include a breakpoint data register 410a, a breakpoint address register 410b, and a breakpoint count register 410c.

The debug logic circuit 400 includes a multiplexer 706, which has as inputs the data memory address bus 702 and the program memory address bus 704. The multiplexer 706 produces one of these inputs on its output depending on a select signal 708, which is coupled to the PPDAT bit in the ICKBUG register. If the PPDAT bit is set to “1,” the contents of the data memory address bus will appear at the output of the multiplexer 706. If the PPDAT bit is set to “0,” the contents of the program memory address bus will appear at the output of the multiplexer 706.

The output of the multiplexer 706 is coupled to one input of an address comparator 710. The other input of the address comparator 710 is coupled to the breakpoint address register 410b. The address comparator 710 has an output which is high if the output of the multiplexer 706 equals the contents of the breakpoint address register 410b. Thus, the combination of the multiplexer 706 and the address comparator 410b can be used to compare either the contents of the data memory address bus 702 or the contents of the program memory address bus 704 to the contents of the breakpoint address register 410b.

The combination of the address comparator 710 and two 4-input AND gates 712, 714 forms a compare circuit 716 indicated by a dashed box in FIG. 7. The output of AND gate 712, an address-equal-on-read signal 718, is high when the READ signal from the CPU is high, the DATRW bit is low, the PPDAT bit is high, and the output of the address comparator 710 is high. Thus, the address-equal-on-read signal indicates that contents of the program memory address bus 704 (PPDAT is high, causing that bus to be selected by the multiplexer 706) matched the contents of the breakpoint address register 410b, on a read cycle when it was desired to look for such a match (DATRW high).

The output of AND gate 714, an address-equal-on-write signal 720, is high when the WRITE signal from the CPU is high, the DATRW bit is high, the PPDAT bit is high, and the output of the address comparator 710 is high. Thus, the address-equal-on-write signal indicates that contents of the program memory address bus 704 (PPDAT is high, causing that bus to be selected by the multiplexer 706) matched the contents of the breakpoint address register 410b, on a write cycle when it was desired to look for such a match (DATRW high).

An OR gate 722 ORs the address-equal-on-read and address-equal-on-write signals. The resulting signal is ANDed with an inverted signal coupled to the DCMP bit by AND gate 724. Thus, the output of AND gate 724 is high for either a read or a write when the contents of the program memory address bus 704 match the contents of the breakpoint address register 410, the PPDAT bit is high, and no data comparison is done (the DCMP bit is low). The output of the AND gate 724 is ORed by OR gate 726 to produce a breakpoint signal 728.

A second input to OR gate 726, and thus a second source of the breakpoint signal 728, is the output of AND gate 730. One of the inputs to the AND gate 730 is the output of a data comparator 732, which is high if the contents of the data memory data bus 700 equal the contents of the breakpoint data register 410a. Otherwise it is low.

A second input to the AND gate 730 is the DCMP signal. Thus, the output of the AND gate 730 cannot be high unless the DCMP signal is high, indicating that a data compare is desired.

The third input to the AND gate 730 is the output of OR gate 722, which will be high under the circumstances described above.

Thus, the output of the OR gate 722 will be high, producing a breakpoint signal 728 at the output of OR gate 726, if (1) the DCMP bit is high (indicating that a data compare is desired), (2) there is a match between the contents of the data memory data bus 700 and the breakpoint data register 410a, (3) there is a match on read (if DATRW is low) or write (if DATRW is high) between the contents of the program memory address bus 704 and the contents of the breakpoint address register 410b and (4) the PPDAT bit is high.

The third input to the OR gate 726, and thus a third source of the breakpoint signal 728, is the output of AND gate 734 which has as inputs the inverse of the signal coupled to the PPDAT bit and the output of the address comparator 710. This signal will be high when the contents of the data memory address bus equal the contents of the breakpoint address register 410b and PPDAT is low. In the exemplary embodiment illustrated in FIG. 7, when PPDAT is low, the GLOBUG register is the breakpoint data register 410a and the breakpoint address register is only 12 bits.

The breakpoint signal 728 is used to downclock a breakpoint counter 730. In some debug applications (discussed below), the breakpoint counter 730 is loaded by storing a value in the breakpoint count register 410c and then asserting the run-until-break-control signal 732. When the contents of the breakpoint counter 730 equal 00H and the down clock signal is asserted, an underflow condition will occur, causing an underflow output of the breakpoint counter to be asserted, which produces the break signal 405.

In use, the personal computer 105 would store in the breakpoint count register 410c the number of passes by a particular breakpoint that are desired before interrupting the CPU. The personal computer 105 would then cause the run-until-break-control signal 732 to be asserted, loading the breakpoint counter 730. Thereafter, every time that breakpoint is encountered, the breakpoint counter 730 would be decremented until it reaches zero. The next time the breakpoint is encountered, the breakpoint counter 730 would underflow and produce the break signal.

In one exemplary embodiment, the microcontroller is interrupted or halted when a breakpoint occurs. The typical HALT method is by breakpoint. To enter breakpoint mode, the BKBUG configuration bit is set to “0.” When the PPDAT bit is “0,” the ICKBUG, BIGBUG and GLOBUG registers contain a 20 bit value that is compared against PC (the value of the program counter). Bit zero of PC is not compared to the breakpoint value because, in the exemplary embodiment, it is assumed to be zero. When the values are equal and INBUG bit is not set, the circuit will generate a break signal on that cycle.

If the CNTBUG register 00H, the system will break on the first occurrence of an address match.

The ICKBUG, BIGBUG and GLOBUG registers are mapped in an overlay of the user memory space. When the BKBUG bit is enabled, the breakpoint address registers can be read and written. The power off and master clear initialization state of these registers will be 000000h, equal to the reset vector.

Disabling the breakpoints is implemented by setting the breakpoint address to all ones (1FFFFFH). When the breakpoint address is set to the last location of addressable program space, no breakpoint will occur as long as execution takes place in user program memory.

If the breakpoint is set to PC, the instruction at PC will be executed, and the stack will point to PC+2 for the trap return. No manipulation of the stack is required for program address breakpoints.

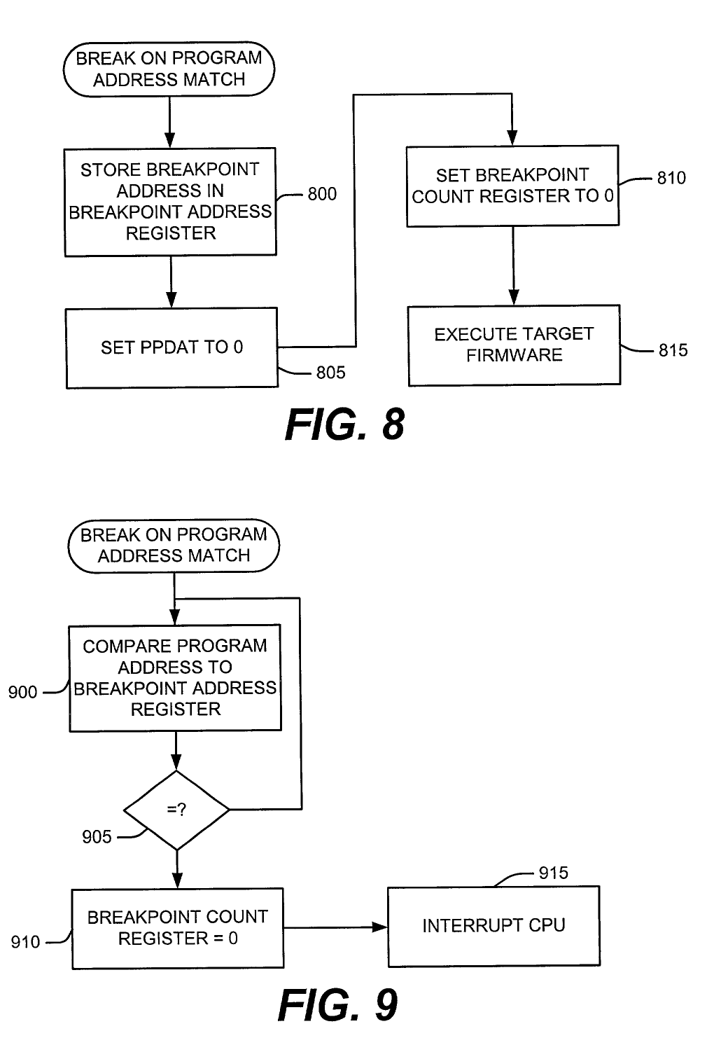

The system provides the ability to break on program address match, as shown in FIGS. 8 and 9. Breakpoints of this type occur on an address match of the first address fetch of any two cycle instruction. A breakpoint on address match will typically not occur on an address match if the address is pointing to the second word of a two-word instruction or if the address is generated for TBLRD or TBLWT instructions, which treat program memory as data memory. For the case of conditional instructions, the second fetch of a two-cycle instruction points to a “dummy address,” so the breakpoint address is invalid. For two word instructions, the second fetch is only an operand. The breakpoint would typically not be set to an operand address in an application.

To initiate a breakpoint on program address match, the personal computer 105, through the protocol translator gateway 110 and the serial I/O 305, or the serial I/O shown in FIG. 5, would first store the breakpoint address in the breakpoint address register 410b (block 800). This would cause data representing the desired breakpoint address to be stored in bits BKA19-BKA00 in the ICKBUG register, the BIGBUG register and the GLOBUG register. The PPDAT bit in the ICKBUG register would then be set to zero (block 805), and the breakpoint count register would be set to zero (block 810). The target firmware would then be executed (block 815).

As the target firmware is being executed, the contents of the program memory address bus 704 would be compared to the contents of the breakpoint address register 410b (block 900). If they are equal (block 905), and the breakpoint count register equals zero (block 910), which it is in this case, the CPU is interrupted (block 915). Thus, using this set of steps, the CPU can be interrupted when the PC equals a particular address.

The exemplary embodiment also supports breakpoints on a predetermined number of program address matches. This type of breakpoint processing is very much like the processing discussed in reference to FIGS. 8 and 9. The difference is that the instruction is executed the predetermined number of times before the CPU is interrupted. To initiate this type of breakpoint processing, a 20 bit value to be compared to the PC is stored in the ICKBUG, BIGBUG and GLOBUG registers. The number of times that the address this value represents is to be fetched (“passed”) is loaded into the CNTBUG register. Each time the breakpoint address register matches the PC, the value in CNTBUG is decremented. Before the CNTBUG register is decremented, the value is compared to zero. If it is zero and the INBUG bit is not set, then the circuit will generate a halt signal on that cycle.

The value to be loaded into CNTBUG is equal to the number of passes to be allowed minus one. This insures backward compatibility with the standard breakpoint halt.

The CNTBUG register must be 00H to break on the first occurrence of an address match. Any other value in CNTBUG, with PPDAT bit equal to “0,” will invoke a passpoint operation and a halt will not occur until CNTBUG equals zero.

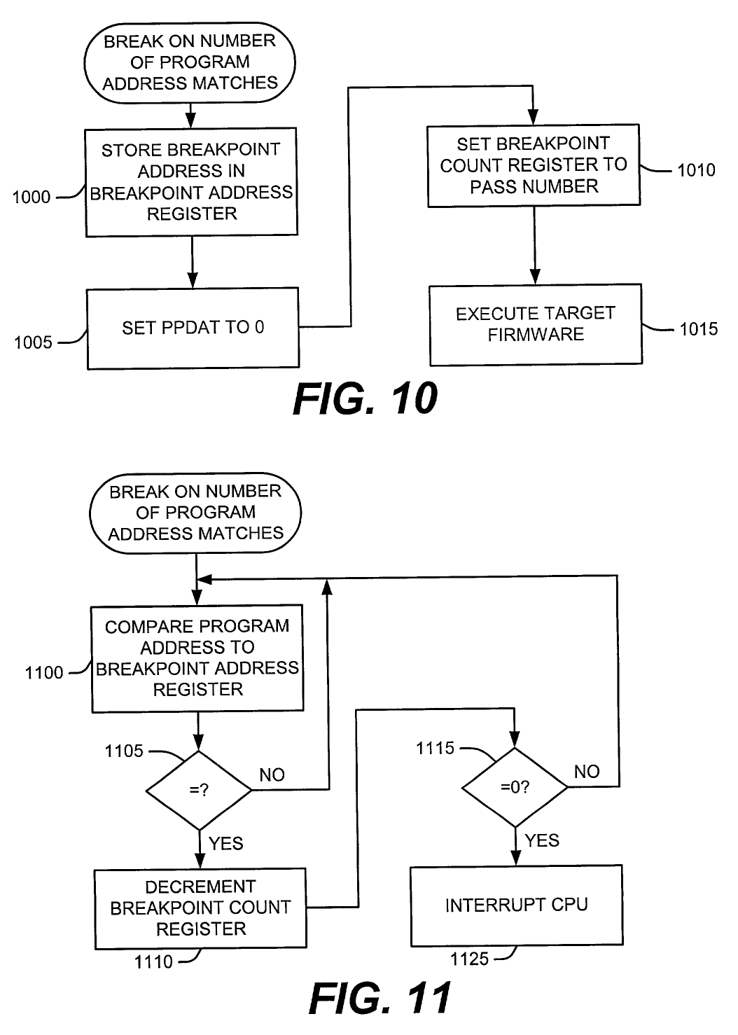

Processing to implement the break on number of program address matches is illustrated in FIGS. 10 and 11. The personal computer sets up this breakpoint mode by storing the breakpoint address in the breakpoint address register 410b (block 1000). The PPDAT bit is set to zero (block 1005), and the breakpoint count register 410b is set to equal the number of desired passes (block 1010). The target firmware is then executed (block 1015).

As the firmware executes, the contents of the program memory address bus 704 are compared to the contents of the breakpoint address register 410b (block 1100 of FIG. 11). A check is made to determine if the contents are equal (block 1105). If not, execution is looped back to block 1100. Otherwise (i.e., if the contents are equal) then the breakpoint count register is decremented (block 1110) and another check is made to determine if the breakpoint count register is equal to zero (block 1115). If the breakpoint count register is not equal to zero, then execution jumps back to block 1100 and the cycle repeats. Otherwise, i.e., if the breakpoint count register is equal to zero, then the CPU is interrupted (block 1125).

The exemplary embodiment also provides the ability to halt execution on a Special Function Register address match. This breakpoint is selected by setting the PPDAT bit to “1.” The ICKBUG and BIGBUG registers are loaded with a 12 bit value that is compared against the output of the multiplexer 706, shown in FIG. 7. Normally, the value in GLOBUG is ignored during an SFR access breakpoint. The type of access is configured by the DATARW bit. When the values are equal and INBUG is not set, the circuit will generate a halt signal on that cycle.

Alternatively, the DCMP bit may be set to cause a compare between the value of the written SFR data and the GLOBUG value. If PPDAT and DCMP are both “1” and the SFR address equals the contents of ICKBUG and BIGBUG and the SFR data equals GLOBUG, a halt signal will be issued in that cycle.

As before, the CNTBUG register will be set to zero if it is desired to break on the first occurrence of a SFR address or address/data match. Any other value in CNTBUG, with the PPDAT bit set to “1,” will invoke a pass point operation and a halt will not occur until the CNTBUG bit equals zero.

The DATARW and the TCMP bits have no effect if PPDAT equals zero.

Because of the delay in the execution of the instruction, the halt occurs on PC+2 instead of PC. The instruction at PC+2 will have been executed and the stack will be pointing to PC+4 as the trap returns.

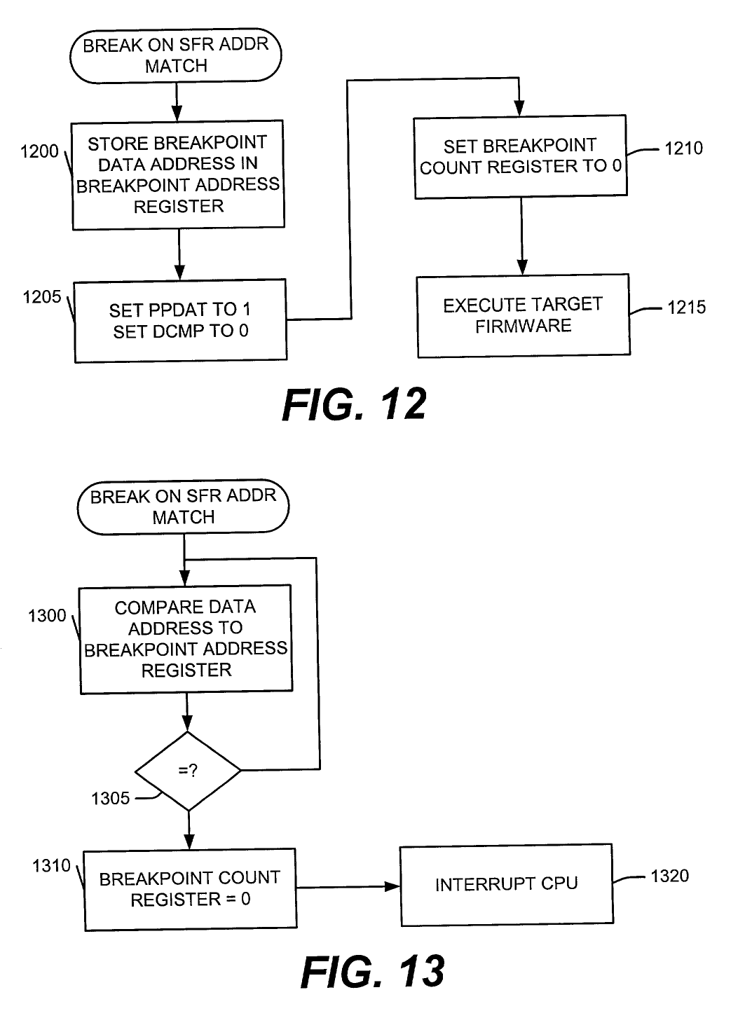

Break on SFR address match processing is illustrated in FIGS. 12 and 13. The personal computer sets up the break on SFR address match breakpoint by storing the breakpoint data address in the breakpoint address register 410b (block 1200). The PPDAT bit is set to one and the DCMP bit is set to zero (block 1205). The breakpoint count register is set to zero (block 1210). The target firmware is then executed (block 1215).

As the target firmware is executing, the contents of the data memory address bus 702 are compared to the contents of the breakpoint address register (block 1300). If they are equal (block 1305) and the breakpoint count register equals zero (block 1310), which it does in this case, the CPU is interrupted (block 1320).

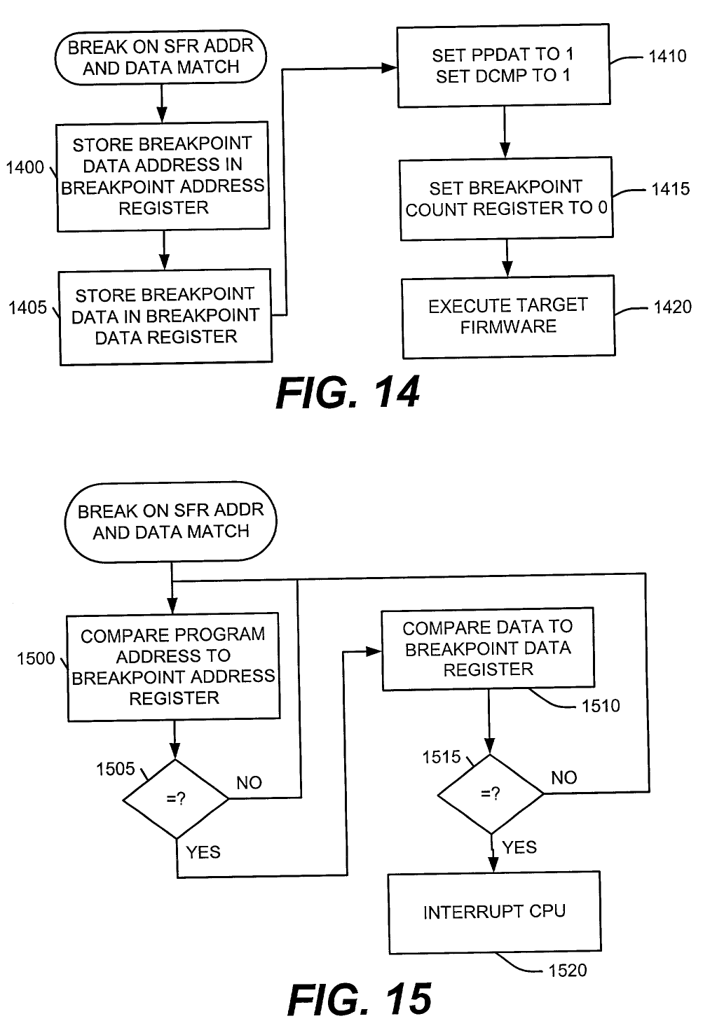

To set up a breakpoint on SFR address and data match, as illustrated in FIGS. 14 and 15, the personal computer stores the breakpoint data address in the breakpoint address register 410b (block 1400). The breakpoint data is then stored in the breakpoint data register 410a (block 1405). The PPDAT bit and the DCMP bit are then set to “1” (block 1410). The breakpoint count register is set to zero (block 1415) and the target firmware is executed (block 1420).

As the target firmware executes, the contents of the program memory address bus 704 is compared to contents of the breakpoint address register 410b (block 1500). If they are equal (block 1505), the contents data memory data bus 700 are compared to the contents of the breakpoint data register 410a (block 1510). If they are equal (block 1515), the CPU is interrupted (block 1520).

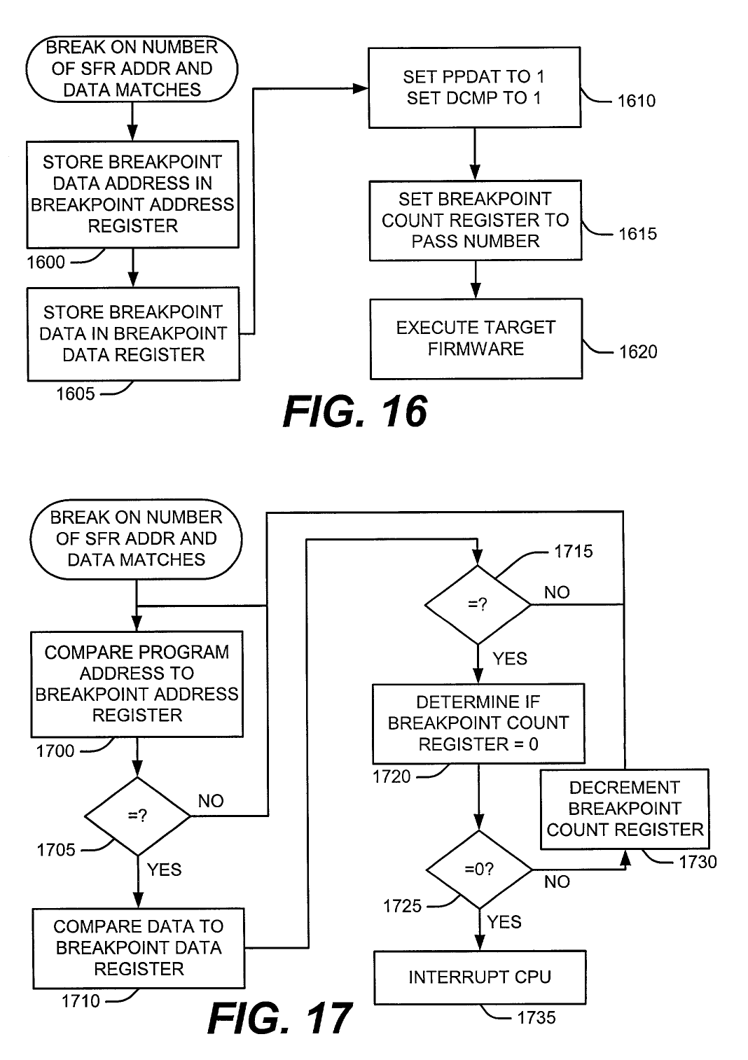

To set up a breakpoint on a number of SFR address and data matches, as illustrated in FIGS. 16 and 17, the personal computer stores the breakpoint data address in the breakpoint address register 410b (block 1600). The breakpoint data is then stored in the breakpoint data register (block 1605). The PPDAT and DCMP bits are then set to “1” (block 1610). The breakpoint count register is set to the number of passes desired (block 1615), and the target firmware is executed (block 1620).

As the target firmware executes, the contents of the program memory address bus 704 are compared to the contents of the breakpoint address register 410b (block 1700). If they are equal (block 1705), the contents of the data memory data bus 700 are compared to the contents of the breakpoint data register 410a (block 1710). If they are equal (block 1715), the breakpoint count register 410c is examined to determine if it is zero (block 1720). If it is not equal to zero (block 1725), the breakpoint count register 410c is decremented (block 1730) and the loop repeats. If the breakpoint count register 410c equals zero the CPU is interrupted (block 1735).

A breakpoint may also occur on stack overflow and underflow conditions. Under software control, the stack overflow and underflow can cause a device to vector to the debug code. This is enabled by the STKBRK bit. If either the stack overflow or underflow bits are set, a force trap is generated on that cycle.

If both the STKBRK and the STVRE bit are set, an overflow or underflow will set the appropriate stack overflow or stack underflow bits and cause a trap to the debug handler.

When such a breakpoint occurs, the stack is already full. Therefore, the trap execution will overwrite the last return address in the stack with a trap return address. The stack will then contain the sequence that caused the stack overflow, so the user has visibility to the sequence. It is up to the debugger system code in the personal computer to correctly handle the subsequent execution. In most cases, the user will not continue with the code, but will debug and reset the device.

The stack overflow and stack underflow bits are not cleared until the user or debugger software clears them or a power on reset clears them.

The invention, therefore, is well adapted to carry out the objects and attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. An embedded system capable of being debugged comprising:
a CPU;
a bus coupled to the CPU, the bus having contents;
a register, having contents which can be loaded by the CPU;
a debug logic circuit coupled to the bus and to the CPU, where the debug logic circuit comprises
a breakpoint detect circuit coupled to the bus and the register; and
a breakpoint signal produced by the breakpoint detect circuit when the contents of the register equal the contents of the bus.

2. The embedded system of claim 1 where
the bus includes an address bus;
the register includes a breakpoint address register; and
the breakpoint detect circuit is configured to produce the breakpoint signal when the contents of the address bus equal the contents of the breakpoint address register.

3. The embedded system of claim 1 where
the bus includes a data memory address bus and a program memory address bus;
the register includes a breakpoint address register; and
the breakpoint detect circuit includes a multiplexer, having an output which can be selected to be the contents of the data memory address bus or the program memory address bus.

4. The embedded system of claim 3 where
the breakpoint detect circuit includes an address comparator which is coupled to the output of the multiplexer and the breakpoint address register, the comparator producing a data-memory-address-equal signal when:
the output of the multiplexer is selected to be the contents of the data memory address bus; and
the output of the multiplexer equals the contents of the breakpoint address register.

5. The embedded system of claim 3 where
the breakpoint detect circuit includes a compare circuit which is coupled to the output of the multiplexer, the breakpoint address register, a read signal, a write signal, and a data read/write signal, the compare circuit producing an address-equal-on-read signal when:
the output of the multiplexer is selected to be the data memory address bus;
the output of the multiplexer equals the contents of the breakpoint address register;
the read signal has been asserted; and
the data read/write signal has been asserted;
the compare circuit producing an address-equal-on-write signal when:
the output of the multiplexer is selected to be the data memory address bus;
the output of the multiplexer equals the contents of the breakpoint address register;
the write signal has been asserted; and
the data read/write signal has been asserted;
where the breakpoint detect circuit is configured to produce the breakpoint signal when a data-value-compare-select signal is not asserted and the compare circuit has produced either the address-equal-on-read signal or the address-equal-on-write signal.

6. The embedded system of claim 5 wherein
the register includes a breakpoint data register;
the bus includes a data memory data bus;
the debug logic circuit includes a data comparator coupled to the breakpoint data register and the data memory data bus which produces a data-equal signal when the contents of the data memory data bus equal the contents of the breakpoint data register
where the breakpoint detect circuit is configured to produce the break signal when the data-value-compare-select signal is asserted, the data-equal signal is produced, and the compare circuit has produced either the address-equal-on-read signal or the address-equal-on-write signal.

7. The embedded system of claim 1, further comprising
a breakpoint counter coupled to the breakpoint detect circuit and responsive to the breakpoint signal for counting the number of breakpoint signals down from a preset number.

8. The single-chip microcontroller of claim 7, where the preset number is one.

9. A method for debugging an embedded system comprising a microcontroller, the microcontroller comprising a CPU, the method comprising
programming a debug logic circuit residing on the same chip as the microcontroller to detect a predetermined condition in the microcontroller;
running an application software on the microcontroller;
detecting the predetermined condition;
interrupting the CPU; and
providing the ability to view the condition of the microcontroller.

10. The method of claim 9 where
programming comprises
storing a breakpoint address in a breakpoint address register;
selecting a program memory address bus to compare to the contents of the breakpoint address register; and
setting a breakpoint count register to 0;
detecting and interrupting comprise,
comparing the contents of the program memory address bus to the contents of the breakpoint register; and
if they are equal, interrupting the CPU.

11. The method of claim 9 where
programming comprises
storing a breakpoint address in a breakpoint address register;
selecting a program memory address bus to compare to the contents of the breakpoint address register; and
setting a breakpoint count register to a predetermined number;
detecting and interrupting comprise,
comparing the contents of the program memory address bus to the contents of the breakpoint register,
if they are equal and the breakpoint count register is not zero, decrementing the breakpoint count register; and
if they are equal and the breakpoint count register is zero, interrupting the CPU.

12. The method of claim 9 where
programming comprises
storing a breakpoint address in a breakpoint address register;
selecting a data memory address bus to compare to the contents of the breakpoint address register; and
setting a breakpoint count register to zero;
detecting and interrupting comprise
comparing the contents of the data memory address bus to the contents of the breakpoint register;
if they are equal, interrupting the CPU.

13. The method of claim 9 where
programming comprises
storing a breakpoint address in a breakpoint address register;
storing a breakpoint data in a breakpoint data register;
selecting a data memory address bus to compare to the contents of the breakpoint address register;
specifying that data is to be compared; and
setting a breakpoint count register to zero;
detecting and interrupting comprise,
comparing the contents of the data memory address bus to the contents of the breakpoint address register;
comparing the contents of the data memory data bus to the contents of the breakpoint data register;
if they are both equal, interrupting the CPU.

14. The method of claim 13 where
programming further comprises
specifying that the breakpoint is to occur on a write; and
comparing the contents of the data memory address bus to the contents of the breakpoint address register comprises performing the compare on a write.

15. The method of claim 13 where
programming further comprises
specifying that the breakpoint is to occur on a read; and
comparing the contents of the data memory address bus to the contents of the breakpoint address register comprises performing the compare on a read.

16. The method of claim 9 where
programming comprises
storing a breakpoint address in a breakpoint address register;
storing a breakpoint data in a breakpoint data register;
selecting a data memory address bus to compare to the contents of the breakpoint address register;
specifying that data is to be compared; and
setting a breakpoint count register to zero;
detecting and interrupting comprise,
comparing the contents of the data memory address bus to the contents of the breakpoint address register;
comparing the contents of the data memory data bus to the contents of the breakpoint data register;
if they are both equal and the breakpoint count register is not zero, decrementing the breakpoint count register; and
if they are both equal and the breakpoint count register is zero, interrupting the CPU.

17. A debugger comprising:
a bus interface for interfacing to a microcontroller bus;
a communications interface for receiving debug instructions;
a register, having contents which can be loaded through the communications interface;
a breakpoint detect circuit coupled to the bus and the register; and
a breakpoint signal produced by the breakpoint detect circuit when the contents of the register equal the contents of the bus.
